(19) United States
(12) Patent Application Publication
(10) Pub. No.: US 2008/0047202 A1
(43) Pub. Date: Feb. 28, 2008

(54) Glass Door Wing That Can Pivot About an Upper and Lower Trunnion

(75) Inventor: Wilfried Kletscher, Bad Salzuflen (DE)

Correspondence Address: COHEN, PONTANI, LIEBERMAN & PAVANE, 551 FIFTH AVENUE, SUITE 1210, NEW YORK, NY, 10176, US

(73) Assignee: Dorms GmbH + Co. KG, Ennepetal (DE)

(21) Appl. No.: 11/631,578

(22) PCT Filed: Jun. 27, 2005
(86) PCT No.: PCT/EP05/06895

§ 371 Date: Jan. 4, 2007

(30) Foreign Application Priority Data
Jul. 5, 2004 (DE) 102004032628.2

(51) Int. Cl. E05D 7/08; E05F 3/22

(52) U.S. Cl. 49/388

(57) ABSTRACT

A glass door leaf includes a glass pane having upper and lower ends; an upper leaf profile attached to the upper end of the glass pane; an upper pivot reception embedded in the upper leaf profile and disposed adjacent to one lateral side of the glass pane for receiving an upper pivot pin; a door closer concealed in the upper leaf profile, the door closer having a pivoting axle and an actuation arm which at one end is connected to the pivoting axle and at the other end is rotatably connected to a slide member movably guided in a plate-shaped door support strip of an upper sub-structure; a lower leaf profile attached to the lower end of the glass pane; and a lower pivot reception embedded in the lower leaf profile and disposed adjacent to the one lateral side of the glass pane for receiving a lower pivot pin.

The invention relates to a glass door leaf, which is pivotable about an upper pivot pin and a lower pivot pin, with leaf profiles forming the upper and lower seals of a glass pane, and with a door closer, which is concealed in the upper leaf profile and has an actuation arm, which at the one end is connected to a pivoting axle of the door closer and, at the other end, is rotatably supported at an upper sub-construction, the pivot pins forming a swing bearing, disposed, at one end of the width of the glass door leaf, between the glass door leaf and the upper sub-construction and a lower sub-construction.

Glass door leaves of the above mentioned species can be used as individual door panels or in combination with stationary glass panels, which laterally adjoin the glass door leaf. The additional disposition of a door closer effects, in particular under unfavourable atmospheric conditions, the desired automatic closing of the door. Glass door leaves of this species integrate with multi-leaf entrance doors, where the individual door panels are both pivotable and displaceable into a parking position by means of an upper roller rail guide.

The invention to be explained in the following relates to the technical embodiment of a glass door leaf, which, in relation to the associated upper or lower sub-construction, is pivotably supported only, i.e. it is intended to forgo the displaceable support in an upper guiding rail.

A device of this species is known from DE 101 57 805 A1. In the prior art device, a pivotable door leaf panel integrates with a sliding wall, which panel is both displaceable and pivotable. For this purpose, the door leaf panel is suspended at a carriage, which is disposed at about half-way of the width of the door leaf panel and carries the door leaf panel and has a pivoting axle for the door leaf panel. A second pivoting axle is formed through the pivot pin of a door closer. At its other end, the actuating arm connected to the pivot pin of the door closer is supported, via a rotating axle, at a pivot bearing forming a component of the sub-construction. When pivoting the door leaf panel, as a result of the pivoting axle being disposed at about half-way of the width of the door leaf panel in the area of the carriage, the door leaf panel will pivot with its frontal edges delimiting the width of the door leaf panel to both sides of the guiding rail, which guides the carriage. This requires provision of sufficient space on both sides of the closed initial position. Furthermore, adjoining the proper upper sub-construction, a hollow cylindrical attachment profile with a roller rail disposed below the attachment profile requires a comparatively high construction height of the overall device.

DE 94 21 374 U1 relates to a pivotable sliding door consisting of displaceable door leaves, wherein the two central ones are formed as displaceable leaves and the two exterior ones as pivotable leaves, all leaves being pivotable about axles disposed at the end of their widths. The leaves have an upper and a lower leaf profile respectively, clamping between them a glass pane, which profile is joined by an additional transverse beam, which is hollow cylindrical in cross-section. The transverse beam serves for the concealed reception of a door closer, the actuating arm thereof being supported at the other end by means of a slide member likewise in a hollow cylindrical frame profile forming a component of a sub-construction. As the leaf profile, the transverse beam and the frame profile are superposed, the prior solution assumes having sufficient room height.

It is an object of the invention, while forgoing the displaceability of the door panel, to improve a glass leaf door of the species mentioned above in so far as, with a concealed disposed door closer and the use of the sliding leaf door as a double-action door, by means of a suitable disposition of the swing bearings and of the door closer in conjunction with a special embodiment of the upper sub-construction the utilization of the glass leaf door is likewise possible, even if only a relatively small construction height is available.

The invention solves the given problem with the teaching according to claim 1.

According to the invention, both the upper and the lower swing bearings as well as the door closer are disposed within the respective leaf profile, the sub-construction, which receives the slide member of the door closer, being formed as a flat plate in an inexpensive and space saving way, the thickness of the plate being only determined by the reception of the slide channel.

Further advantageous embodiments of the invention are the subject matter of the dependent claims.

The invention allows for realizing a glass door leaf, which can be used as a double-action door, where just a low construction height is available, which fact is further enhanced, if the pivot pin, disposed in the lower pivot reception, engages in a bearing plate, which forms the lower sub-construction and is screwed to the floor.

As the pivot pins, forming the upper and the lower swing bearings, are each disposed in a pivot reception embedded in the upper and the lower leaf profiles, it is sufficient to clamp the glass pane between the upper and the lower leaf profiles, such that the frontal edges delimiting the width of the glass pane can be formed frameless.

In the following, the invention will be explained in more detail, reference being made to an exemplary embodiment, in which:

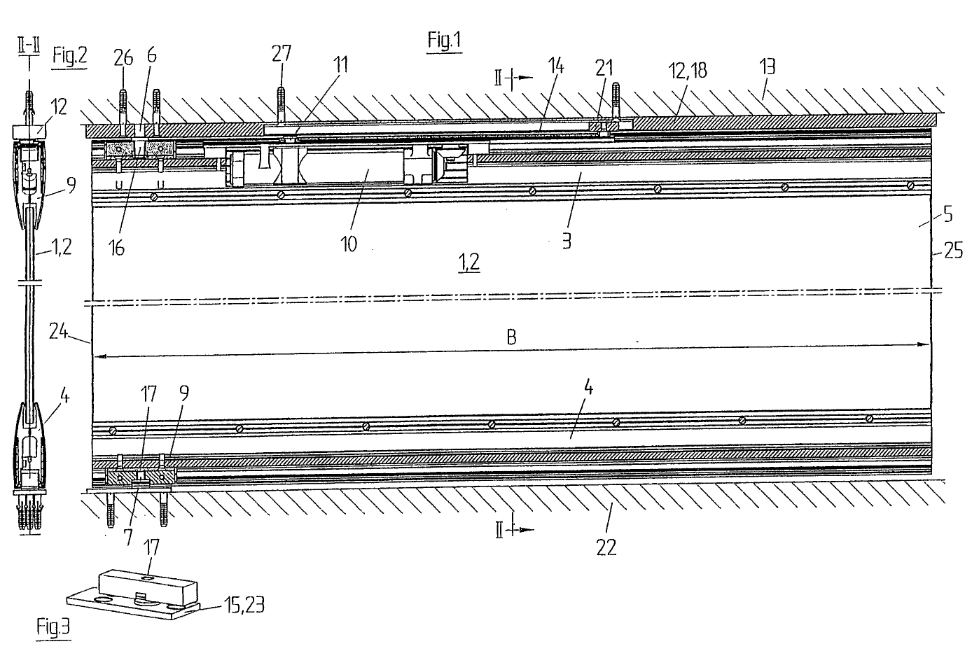

FIG. 1 shows a vertical longitudinal section through the glass leaf door;

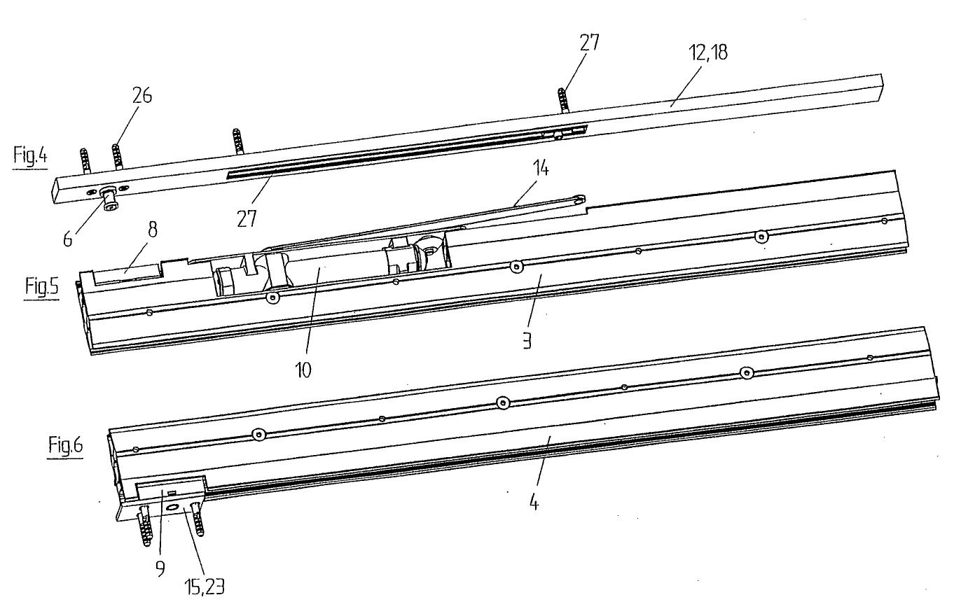

FIG. 2 shows the section according to line II-II in FIG. 1;

FIG. 3 shows a perspective enlarged illustration of the lower swing bearing;

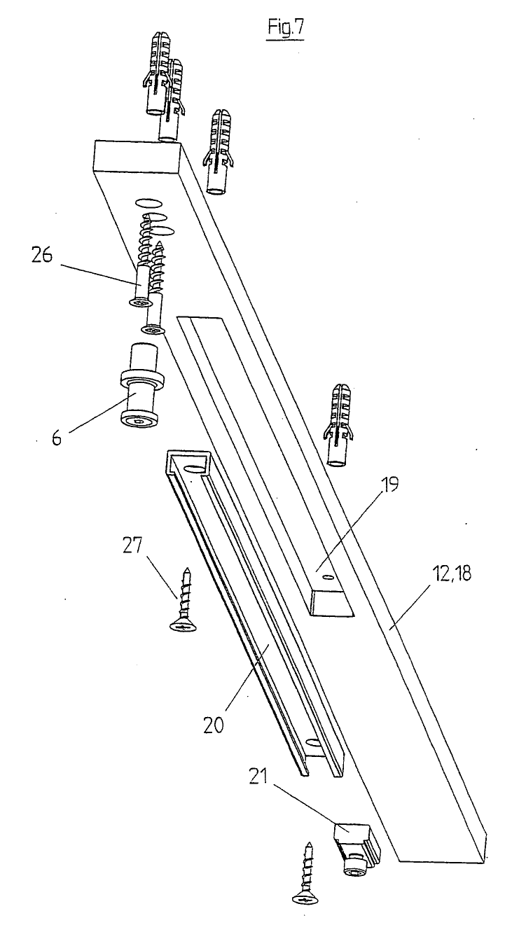

FIG. 4 shows the door support strip in a perspective illustration enlarged in relation to FIG. 1;

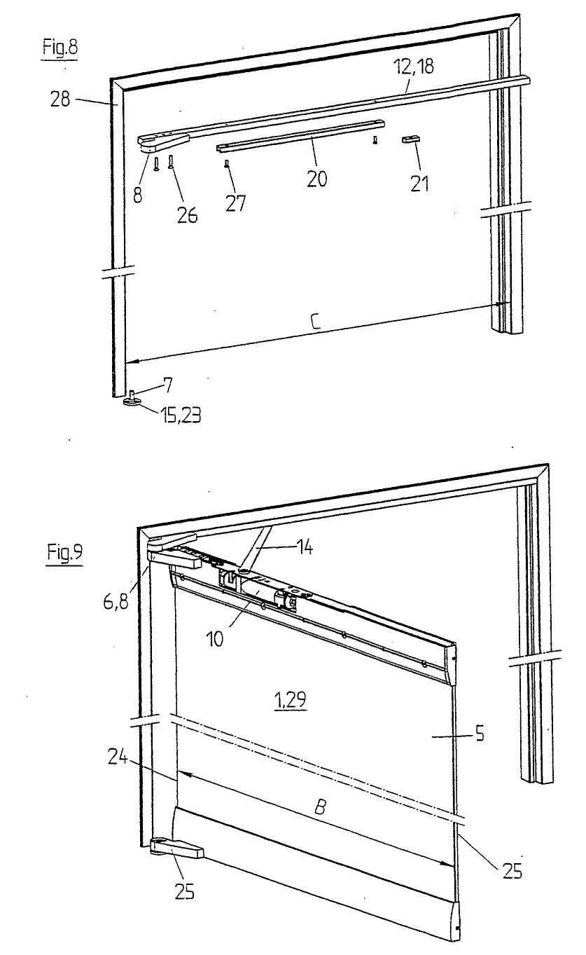

FIGS. 5 and 6 show the upper leaf profile or the lower leaf profile in a perspective illustration; and

FIG. 7 shows, in a perspective illustration in relation to FIG. 4 and as an exploded view, the door support strip including the slide channel.

According to FIG. 1, a glass door leaf 1 is formed as a double-action door 2, a glass pane 5 being clamped between an upper leaf profile 3 and a lower leaf profile 4. A pivot pin 6 forming an upper swing bearing 8 is disposed in the upper leaf profile 3 and a pivot pin 7 forming a lower swing bearing 9 is disposed in the lower leaf profile 4. The pivot pins 6 and 7 are respectively supported in an upper pivot reception 16 or in a lower pivot reception 17 and thus form the upper swing bearing 8 or the lower swing bearing 9. As can be seen, the swing bearings 8 and 9 are embedded in the upper leaf profile 3 or in the lower leaf profile 4 respectively. The upper pivot pin 6 engages in a door support strip 18 forming an upper sub-construction 12; the lower pivot pin 7 engages in a support plate 23, which is screwed to the floor 23 and forms a lower sub-construction 15.

A door closer 10 is concealed in the upper leaf profile 3, the actuating arm 14 thereof being connected to a pivoting axle 11 of the door closer 10. As can be seen particularly in FIG. 7, an opening 19 delimited on the front side is provided in the plate-shaped door support strip 18, which forms the upper sub-construction 12 and is connected to the ceiling 13 via screw connections 26, into which opening a slide channel 20 will be inserted by means of further screw connections 27. A slide member 21, disposed at the free end of the actuating arm 14, is forcibly guided in the slide channel 20.

As the upper or lower leaf profiles 3 and 4, illustrated in FIGS. 5 and 6, reliably clamp the glass pane 5, the frontal edges 24 and 25 of the glass pane 5, as depicted in FIG. 1, delimiting the width B of the double-action door 2, can be formed frameless.

### LIST OF REFERENCE NUMERALS

1 glass door leaf
2 double-action door
3 upper leaf profile
4 lower leaf profile
5 glass pane
6 upper pivot pin
7 lower pivot pin
8 upper swing bearing
9 lower swing bearing
10 door closer
11 pivoting axle
12 upper sub-construction
13 ceiling
14 actuating arm
15 lower sub-construction
16 upper pivot reception
17 lower pivot reception
18 door support strip
19 opening
20 slide channel
21 slide member
22 floor
23 support plate
24 frontal edge
25 frontal edge
26 screw connection
27 screw connection
B width of the glass door leaf

1.-4. (canceled)

5. A glass door leaf for pivotably mounting on upper and lower sub-structures, the door leaf comprising:
a glass pane having two lateral side edges, an upper end, and a lower end;
an upper leaf profile attached to the upper end of the glass pane;
an upper pivot member supported by the upper leaf profile and disposed adjacent to one of the lateral side edges, the upper pivot member comprising one of an upper pivot pin and a complementary upper pivot pin receiving bearing, the other of the upper pivot pin and the complementary upper pivot pin receiving bearing being supported by the upper sub-structure;
a door closer supported by the upper leaf profile, the door closer having a pivoting axle and an actuation arm having a first end which is connected to the pivoting axle and a second end which is rotatably connected to a slide member movably guided in a slide channel, the slide channel being releasably embedded in an opening of a plate-shaped door support strip of the upper sub-structure, the door support strip being fastened to a ceiling;
a lower leaf profile attached to the lower end of the glass pane; and
a lower pivot member supported by the lower leaf profile and disposed adjacent to the one lateral side edges, the lower pivot member comprising one of a lower pivot pin and a complementary lower pivot pin receiving bearing, the other of the lower pivot pin and the complementary lower pivot pin receiving bearing being supported by the lower sub-structure;
wherein the upper and lower pivot pins are disposed in the complementary upper and lower pivot pin receiving bearings, respectively, so that the glass door leaf is pivotable about the upper and lower sub-structures.

6. The glass door leaf of claim 5, wherein the lower pivot member is the complementary lower pivot pin receiving bearing, and the lower pivot pin engages in a support plate which is fastened to a floor and forms the lower sub-structure.

7. The glass door leaf of claim 5, wherein the lateral side edges are frameless and define a width of the glass pane.

8. The glass door leaf of claim 5, wherein the door support strip extends over the entire width of the glass pane.
